(19) United States
(12) Patent Application Publication
(10) Pub. No.: US 2004/0181566 A1
(43) Pub. Date: Sep. 16, 2004

(54) Power raising circuit

(76) Inventors: Donato Ettorre, Torino (IT); Bruno Melis, Torino (IT); Alfredo Ruscitto, Torino (IT)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/487,106

(22) PCT Filed: Aug. 14, 2002
(86) PCT No.: PCT/IT02/00539

(30) Foreign Application Priority Data
Aug. 17, 2001 (IT) TO2001A000818

(51) Int. Cl. G06F 7/38

(52) U.S. Cl. 708/606

(57) ABSTRACT

An iterative power raising circuit, such as a squarer (10) comprises a module (13, 14) able to subdivide the respective input signal (Zₙ) into a first part (msb(Zₙ)) that is the power of 2 immediately lower than or equal to the input signal and a second part (Zₙ−msb(Zₙ)) corresponding to the difference between the respective input signal and the first part. A first component of the output signal is determined as the summation of squares of powers of 2 implemented by inserting zeros between the adjacent bits of the input binary signal (X). A shifter module (15) generates an additional component of the output signal through shift operations that implement multiplication operations for numbers that are powers of 2. The circuit operates according to a general iterative scheme and the number of steps in the iteration scheme is selectively controllable in order selectively to vary the precision with which the output value (Y) is calculated.

### TECHNICAL FIELD

The present invention relates to power raising circuits, i.e. to circuits that, starting from an input signal X representative of a given number, generate as output a signal Y=X^{k} representative of the k-th power of the input data item.

In the most common application the value of k is 2 and the circuit is configured as a squarer circuit.

### BACKGROUND ART

Fast squarer circuits, able efficiently to exploit the semiconductor area whereon they are integrated, constitute essential blocks for systems for the digital processing of signals.

For example, in the telecommunications industry there are many circuits (channel estimators, delay locked loop or DLL, power detectors, etc.) that require rapidly to calculate the square of a numerical value.

In this regard, reference can usefully be made to the well known volume by J. G. Proakis, “Digital Communications”, 3rd edition, McGraw-Hill, 1995.

In the same industry, applications are also known which require calculating higher order powers: it is the case, for example, of the so-called pre-distorters used to compensate the signal distortion phenomena induced by microwave power stages.

In all applications considered above, the circuits must be sufficiently small to be integrated in high numbers even on a single chip.

In addition to speed and size (occupied area), another factor to take into consideration is given by the precision or accuracy of the result achieved. There are different applications that require only a broad accuracy and not the absolute determination of the exact value of the results of the power raising operation.

Prior art power raising circuit solutions mostly derive from the array multiplier scheme: see, for instance, the document U.S. Pat. No. 5,629,885.

Regardless of all other considerations, said solutions are to a greater or lesser extent constrained by a rigidity of configuration and of operation. In particular, said prior art solutions are not easy to programme in terms of required precision or accuracy and do not allow—for example—to “exchange” the degree of required accuracy and/or occupied area with computing time.

In this regard it should further be noted that, at least in some applications, a particularly fast power raising circuit (e.g. a squarer) can actually be revealed to be —given its considerable occupied area—a widely unused resource. This is because, after rapidly performing its function, the circuit in question is then forced to wait (giving rise to idle time) for the completion of processing operations performed more slowly by other circuits whereto the power raising circuit is associated.

### DISCLOSURE OF THE INVENTION

The aim of the present invention is to provide a power raising circuit that is able to overcome the intrinsic drawbacks of the prior art solutions.

According to the present invention said aim is achieved thanks to a circuit having the characteristics specifically described in the claims that follow.

Briefly, the solution according to the invention exploits, for purposes of simplification and of reducing the computational burden the fact that part of the power raising operation can be derived from operations performed on numbers that are powers of 2. This concepts was, in itself, already used in WO-A-00/33174, where the square of a certain number is estimated by means of a linear approximation of the function y=x² performed between two reference points (anchor points) corresponding to powers of 2.

With respect to said known solution, the circuit according to the invention offers—among others—the advantage of being fully programmable in terms of precision of the final result obtained. In particular, precision can be modified during its operation, simply by changing the maximum number of iterations, parameter which can be controlled externally, for instance, by means of a DSP (Digital Signal Processor).

This advantage is shared by the solution according to the invention with a multiplier circuit described in a patent application for industrial invention filed on the same date by the same Applicant.

The solution according to the invention also allows to obtain a considerable reduction in terms of occupied area with respect to traditional solutions.

### BRIEF DESCRIPTION OF DRAWINGS

The invention shall now be described, purely by way of non limiting example, with reference to the accompanying drawings, in which:

FIGS. 1 and 2 are destined to illustrate in geometric terms the theoretical principles whereon the invention is based,

FIG. 3 shows, in the form of a block diagram, the structure of a circuit according to the invention,

FIG. 4 shows the possible criteria for realising one of the modules represented in the block diagram of FIG. 3, and

FIG. 5 is a flow chart that illustrates the operation of the circuit shown in FIG. 3.

### BEST MODE FOR CARRYING OUT THE INVENTION

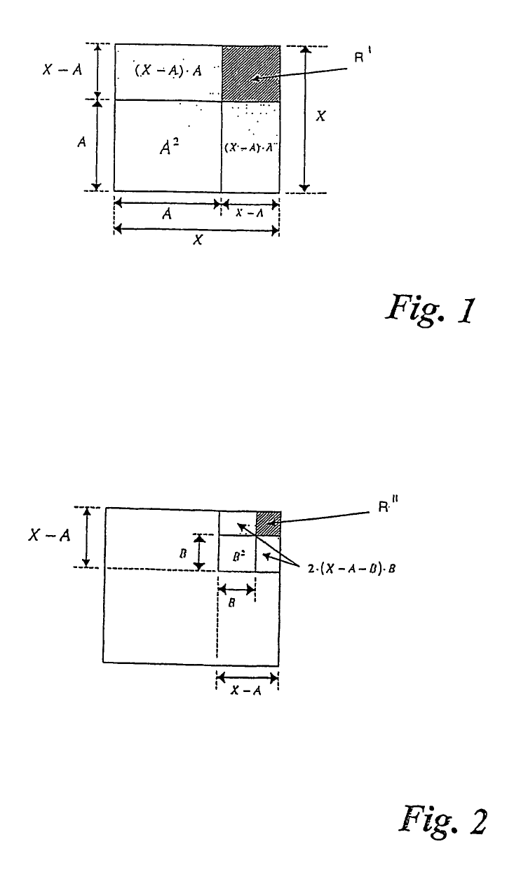

By way of foreword to the present description it seems useful to illustrate, referring to FIGS. 1 and 2, the (geometric) principle whereon the operation of the circuit according to the invention is based. For reasons of simplicity, the illustration is provided with reference to raising to the square power: it is nonetheless readily apparent that the same concepts can be applied and extended to a power of any order k.

It is presumed that X represents the number whereof the square is to be calculated Y=X².

As normally occurs in digital signal processing circuits, the value X is represented by a binary signal, i.e. by a string of bits that take on the value “0” or “1”.

It will also be presumed that X is any positive number, the handling of a possible sign being easily able to be performed with distinct circuits, known in themselves.

Observing FIG. 1, the value Y=X² represents the area of the square illustrated in FIG. 1.

Let it then be presumed that A is the number constituting the power of 2 immediately lower than or equal to X, i.e., according to a common notation with reference to binary numbers A=msb(X) wherein msb stays for most significant bit.

Observing FIG. 1, it is readily apparent that the value X² can be approximated by the value:

S₁=A²+2·(X−A)·A

The approximated value S1 corresponds to the sum of a first, a second and a third portion of area respectively corresponding:

to the area A² of the square reproduced at the bottom left of FIG. 1,

to the area A·(X−A) of the lower right rectangle, and

to the area A·(X−A) of the upper left rectangle.

These two areas are mutually equal, which explains the presence of the factor 2 in the formula above.

The area of the square R′ represented as a dashed area in the top right side constitutes the approximation error whose value is equal (observing FIG. 1, the geometric meaning of the above statements is readily apparent) to the product (X−A)².

Adopting the same criteria seen above, the value of said error (i.e., in practice, the area of the square R′ shown in FIG. 1) can in turn be approximated in the form of the following product:

S₂=B²+2·(X−A−B)·B

In this case, too, the meaning of the approximation is readily apparent in geometric terms with reference to the representation of FIG. 2.

In this case the value B is identified as the power of 2 less than or equal to (X−A), or B=msb (X−A).

In this case, too, there is a remaining error corresponding to the area of the rectangle R″ represented in the top right corner of FIG. 2.

However, it is readily understandable that the described procedure can be iterated M times (with M=log₂(max(X)−1), where max(X) represents the maximum of the distribution of the possible input values of X) thereby obtaining the exact value of the power raising operation according to the expression:

X²=S₁+S₂+ . . . +S_{M}

Naturally, the one shown in FIGS. 1 and 2 (and in the subsequent sequence of steps through to step M conceptually derivable from the representation of FIGS. 1 and 2) corresponds to the most general iterative criteria that can be hypothesised. In actual fact, M calculation iterations are necessary only for some “critical” values of X, whilst in many other cases to obtain the exact value of X² even a much smaller number of steps is sufficient.

As previously stated, the method according to the invention can also be applied to a power raising factor higher than two, for example to k=3, in which case the square A² of FIG. 1 and FIG. 2 takes on the shape of a cube, and the rectangles of area (X−A)·A the shape of parallelepipeds, etc.

The invention is based on the recognition of the fact that the raising to a power of any number can be achieved by means of a set of:

power raising operations on numbers that are powers of 2, and

product operations of factors

i) that are both powers of 2; or

ii) whereof at least one is a power of 2 (for instance the products A·(X−A)∘B·(X−A−B)).

All these operations can easily be accomplished by means of simple combinatory logic and/of shift operations.

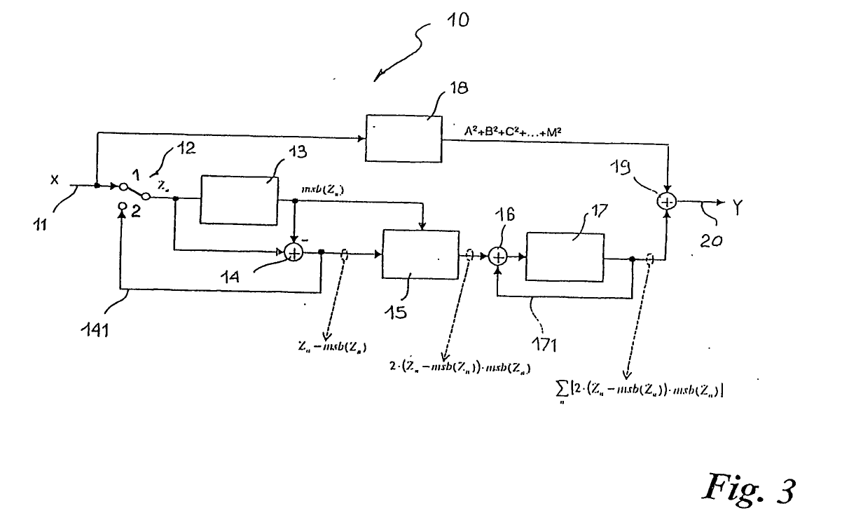

In the diagram of FIG. 3, the numeric reference 10 globally indicates a power raising circuit according to the invention.

The binary digital signal X destined to be raised to power (in the case of the present example, raising to square power) is applied on the input indicated as 11.

The reference 12 indicates a switch that during the first step of the iterative squaring process is in the position indicated as 1. The switch 12 then moves to the position indicated as 2 during the subsequent steps of the iterative process for refining the final result.

The reference 13 indicates a module that, together with a summation node 14 associated thereto, subdivides the respective input signal Zₙ into a first part msb(Zₙ) that is the power of 2 immediately lower than or equal to Zₙ and a second part Zₙ−msb(Zₙ) corresponding to the difference between the respective input signal and the aforesaid first part.

In the remainder of the present description, the symbol Z shall indicate the signals deriving from the signal X, whilst the subscript n shall instead indicate the generic step of the iterative squaring process.

The module 13 in practice determines the aforesaid first part of signal msb(Zₙ) extracting the most significant bit of the binary string brought to its input and masking (i.e. setting to zero) the successive bits.

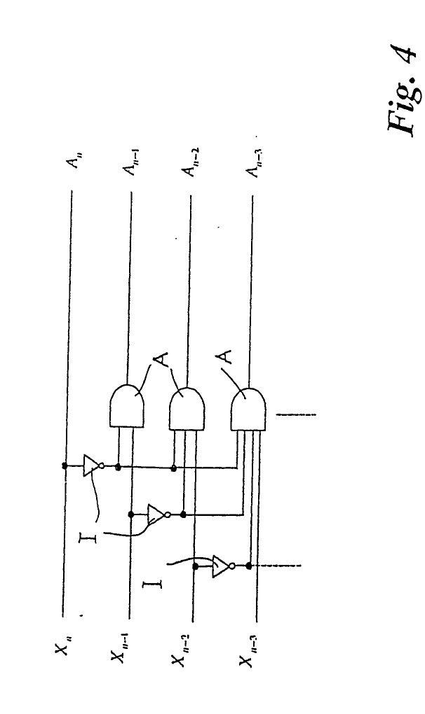

A possible corresponding circuit diagram is shown in FIG. 4, where the reference I and A respectively indicate logic inverters and logic gates of the AND type. The symbols Xₙ, Xₙ₋₁, Xₙ₋₂, . . . and Aₙ, Aₙ₋₁, Aₙ₋₂, . . . indicate, starting from the most significant bit, the bits of the input signal and of the output signal of the module 13.

The summation node 14 receives at its input—with opposite signs—the signals present at the input (positive sign) and at the output (negative sign) of the module 13 and therefore calculates the aforesaid second part of signal. Since msb(Zₙ) is the power of 2 lower than or equal to Zₙ, its value is expressed by a binary string containing a single bit at “1”. The difference Zₙ−msb(Zₙ) can therefore be determined with a combinatory network with elementary structure.

The reference 15 indicates a programmable shifter module that receives as inputs the output signal of the module 13 and the output signal of the summation node 14 in order to calculate products of the type 2−(Zₙ−msb(Zₙ))·msb(Zₙ), as—referring to the geometric examples made previously with reference to FIGS. 1 and 2−the products 2·(X−A)·A or 2·(X−A−B)·B.

Since the factors A, B—or, in general msb(Zₙ)—are powers of 2, the products in question can be implemented with a simple leftward shift.

At the output of the module 15 there is an additional summation node 16 that in turn feeds a register 17 having associated a recirculation line 171 that brings back towards the summation node 16, according to a typical summation and accumulation configuration, the output signal of the register 17.

The reference number 18 indicates a module destined to calculate the component of the output signal Y corresponding to the sum of the terms msb(Z) 2, i.e. to the sum of the terms that, in the case of the first two factors A², B₂, . . . identify the areas of the bottom left squares of FIGS. 1 and 2.

The terms to calculate said squares, terms that are powers of 2, could be obtained from the output of the module 13.

The preferred embodiment of the invention illustrated herein, however, is based on the recognition of the following property.

Let it presumed that, in this case as well, the symbols Xₙ, Xₙ₋₁, Xₙ₋₂, . . . , X₀ indicate, in order starting from the most significant bit, the bits of the input signal X and, in homologous fashion, the symbols Q₂ₙ, Q₂ₙ₋₁, . . . , Q₀ indicate, always in order starting from the most significant bit, the bits of the sum Q=A²+B²+ . . . .

The following relationships then hold true:

Q₂ᵢ=Xᵢ0=<i=<n

Q₂ᵢ₊₁=0. 0=<i<n

This means that the calculation of the sum Q simply indicates the insertion of zeros between adjacent bits of X.

This fact can be easily understood noting, for instance, that the summation of the squares of the powers of 2 (in order, 4, 2 and 1) lower than the number 7— number which can be expressed in binary form as 0111— is equal to 4²+2²+1² i.e. to 21. This summation value can be expressed in binary form as 0(0)1(0)1(0)1, i.e. as the string 0010101 obtained by adding a 0 to the left of each of the last three digits of the string 1000 that expresses the number 7.

It will be appreciated that what was stated above in relation to the sum of the squares also applies to the sum of higher order powers (for example to the sum of the cubed values A³+B³ . . . ) simply increasing the number of zeros inserted between the bits of the value X.

On the basis of this premise, the implementation of the module 18 is readily apparent for the person versed in the art.

Returning to the diagram of FIG. 3, the reference number 19 indicates an additional summation node that receives at its input the output signals of the summation and accumulation register 17 and of the module 18, producing at its output the value (approximate or exact, depending on the number of iterations carried out) of the result Y.

The corresponding signal produced is presented on an output signal indicated as 20.

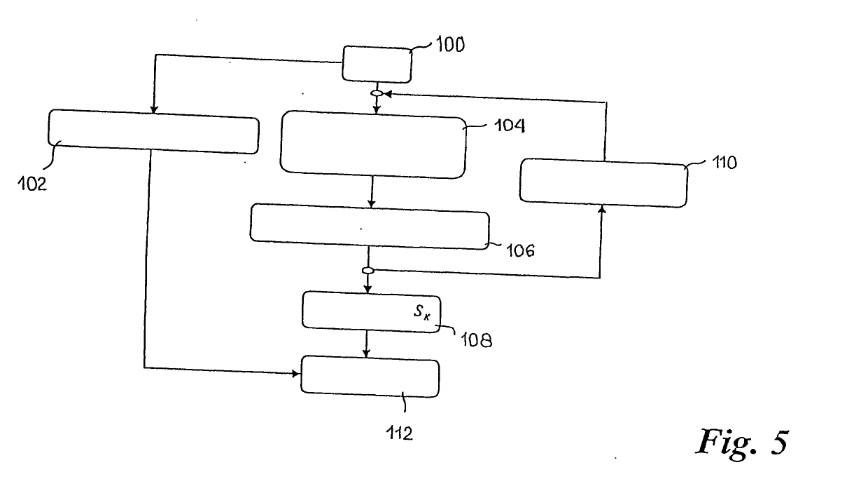

The operation of the circuit of FIG. 3 can be understood referring to the flowchart of FIG. 5 and to the indications shown on the signal propagation paths shown in FIG. 3.

In the initial operating step (step 100 in the diagram of FIG. 5) the binary data item X is brought to the input of the circuit 10 on the line 12. The switch 12 is in the position indicated as 1, so that the value X is fed both to the input of the module 18 and to the input of the module 13.

The module 18 computes, according to the criteria described above, the sum Q=A²+B²+ . . . (step 102).

The module 13 calculates in the first iteration of a step indicated as 104 the value A=msb (X), whilst in the first iteration of a step indicated as 106, the shifter module 15 determines, exploiting also the output signal of the summation node 14, the value 2·(X−A)·A. Said value is then accumulated in the module 17 in a step indicated as 108.

Simultaneously, in step indicated as 110, the factor X-A present at the output of the summation node 14 (which identifies the residual error, i.e. the side of the square R′ in FIG. 1) is sent back through a recycling line 141 towards the switch 13 that has moved to the position indicated as 2.

The subsequent step of the iterative calculation process is thus started.

At the n-th iteration, the process provides for the use, as input towards the module 13, of the signal:

Zₙ=Zₙ₋₁−msb(Zₙ₋₁)

At this point the steps 104, 106 and 108 are repeated, causing the shifter module 15 to determine the value:

Sₙ=2·[Zₙ−msb(Zₙ)]+msb(Zₙ)

which is accumulated in the circuit 17 in view of the sum with output signal of the module 18.

The sum, destined to generate the output signal present on the line 20, is achieved in the module 19 during a step indicated as 112.

As stated previously, the number of steps to be carried out in the iterative calculation process can be selectively imposed from outside the circuit 10, for example by means of a control device or unit such as a DSP, even under run time conditions.

It is also possible to stop the iteration process monitoring the signal present on the recirculation line indicated as 141 and stopping the iterations as soon as this signal becomes equal to zero, which indicates that on the output is present an exact result. This solution appears particularly advantageous in terms of reducing power absorption by the circuit and increasing computing speed.

Upon obtaining the final result (exact or approximate), the circuit 10 is reset in view of the feeding of a new input value X, bringing the switch 12 back to the position 1 and zeroing the content of the accumulation register 17.

It will also be appreciated that the iterative mechanism for refining the result, just described, does not involve the sum Q=A²+B²+ . . . , whose value is determined by the module 18 according to the previously described mechanism for inserting zeros between adjacent bits.

This is particularly advantageous in terms of rapidity of convergence towards the final result, as it allows to determine the contribution represented by the sum Q from the very first step of the calculation process.

The experimental data processed by the Applicant demonstrate that the solution according to the invention allows to obtain particularly satisfactory results in a reduced number of iterations, regardless of the characteristics of the input data item.

Naturally, without changing the principle of the invention, the realisation details and the embodiments may be amply varied relative to what is described and illustrated herein, without thereby departing from the scope of the present invention. This holds true also in regard to the possible presence, at the input of the circuit 10, of elements able to recognised particular values of the data item X, such as to allow to bypass or skip one or more steps of the method described herein.

1. Power raising circuit (10) for generating, starting from a binary digital signal (X), an output signal (Y) representative of the k-th power of said binary digital signal (X), characterised in that it comprises:
an extracting module for extracting powers of 2 (13, 14), able to subdivide a respective input signal (Zₙ) into a first part (msb(Zₙ)) that is the power of 2 immediately lower than or equal to said respective input signal (Zₙ) and a second part (Zₙ−msb(Zₙ)) corresponding to the difference between said respective input signal and said first part,
an input module (12) able to apply said binary digital signal (X) as said respective input signal to said extracting module (13, 14), and
a shifter module (15) co-operating with said extracting module (13, 14) for generating at least a portion of said output signal (Y) by means of a shift operation performed on at least one signal derived from said binary digital signal (X).

2. Circuit as claimed in claim 1, characterised in that said shifter module (15) performs said shift operation acting on the second part (X−A) of said binary digital signal.

3. Circuit as claimed in claim 1 or claim 2, characterised in that it comprises a circuit module (18) for generating at least a respective portion of said output signal (Y) by inserting zeros between the adjacent bits of said binary digital signal (X).

4. Circuit as claimed in any of the previous claims, characterised in that it comprises a summation node (19) for generating said output signal (Y) as a sum of portions of signal (18, 17) respectively corresponding:
to a power of said first part (A) of said binary input signal (X), and
to the product (A·(X−A)) of the first part (A) and of the second part (X−A) of said binary digital signal (X).

5. Circuit as claimed in any of the previous claims, characterised in that:
said input module (12) has associated, according to a general iterative scheme comprising a set of successive steps, a return path (141) for returning to the input of said extracting module (13, 14) the aforesaid second part generated in a previous step of said iterative scheme, as respective new input signal (Zₙ) to be used in a further step of said iterative scheme, and
said shifter module (15) has associated an accumulation element (17) for accumulating new portions of said output signal (Y) generated by said shifter module (19) in subsequent steps of said iterative scheme.

6. Circuit as claimed in claim 4 and claim 5, characterised in that, in each of said steps of said iterative scheme, said shifter module (15) generates a portion of said output signal (Y) to be accumulated in said accumulation element (17), said portion to be accumulated being obtained from a signal (Zₙ) derived from said binary digital signal (X).

7. Circuit as claimed in claim 6 characterised in that said portion of output signal (Y) to be accumulated is obtained starting from the product (msb(Zₙ)·((Zₙ−msb(Zₙ)) of a first part (msb(Zₙ)) and of a second part ((Z−msb(Zₙ)) of signal generated by said at least one extracting module (13, 14) starting from said first binary digital signal (X).

8. Circuit as claimed in any of the claims from 5 to 7, characterised by a control circuit for selectively controlling the number of the steps of said iterative scheme.

9. Circuit as claimed in claim 8, characterised in that said control circuit is sensitive to the signal present on said return path (141) and is able to interrupt the iterative scheme when the aforesaid second part generated in a previous step of said iterative scheme reaches the value of zero.

10. Circuit as claimed in any of the previous claims, characterised in that said extracting module comprises:
an extracting unit (13) that receives said respective input signal (Zₙ) and determines therefrom as respective output signal (msb(Zₙ)) said first part of signal that is the power of 2 lower than or equal to said respective input signal, and
a summation unit (14) that receives with opposite signs said respective input signal (Zₙ) and said respective output signal (msb(Zₙ)) and determines therefrom said second part of signal (Zₙ−msb(Zₙ)).

11. Circuit as claimed in any of the previous claims, characterised in that said power is the power of order 2 of said binary digital signal (X).

12. Power raising circuit (10) for generating, starting from a binary digital signal (X), an output signal (Y) representative of the k-th power of said binary digital signal (X), characterised in that it comprises a circuit module (18) for generating at least a respective portion of said output signal (Y) by inserting k zeros between the adjacent bits of said binary digital signal (X).

13. Method for generating, starting from a binary digital signal (X), an output signal (Y) representative of the k-th power of said binary digital signal (X), characterised by the steps of:
extracting from said binary digital signal (X) representative of a respective input signal (Zₙ) a first part (msb(Zₙ)) that is the power of 2 immediately lower than or equal to said respective input signal (Zₙ) and a second part (Zₙ−msb(Zₙ)) corresponding to the difference between said respective input signal and said first part,
generating at least one portion of said output signal (Y) by means of a shift operation performed on at least one signal extracted from said binary digital signal (X).

14. Method as claimed in claim 13, characterised by the step of
generating said at least one portion of said output signal (Y) by means of a shift operation acting on the second part (X−A) of said binary digital signal.

15. Method as claimed in claim 13 or claim 14, characterised by the step of
generating said at least one portion of said output signal (Y) by inserting zeros between the adjacent bits of said binary digital signal (X).

16. Method as claimed in any of the claims from 13 to 15, characterised by the step of:
generating said output signal (Y) as a sum of portions of signal (18, 17) respectively corresponding:
to a power of said first part (A) of said binary input signal (X), and
to the product (A·(X−A)) of the first part (A) and of the second part (X−A) of said binary digital signal (X).

17. Method as claimed in any of the claims from 13 to 15, characterised by an iterative scheme comprising the steps of:
returning back said second part generated in a previous extracting step of said iterative scheme, as respective new input signal (Zₙ) to be used in a further step of said iterative scheme,
extracting from said respective new input signal (Zₙ) a new first part (msb(Zₙ)) that is the power of 2 immediately lower than or equal to said respective new input signal (Zₙ) and a new second part (Zₙ−msb(Zₙ)) corresponding to the difference between said respective new input signal and said new first part,
generating portions of said output signal (Y) by means of shift operations performed on at least one of said respective new input signal extracted from said binary digital signal (X), and
accumulating said portions of said output signal (Y) in subsequent steps of said iterative scheme.

18. Method as claimed in claim 17, characterised by the step of:
selectively controlling the number of the steps of said iterative scheme.

19. Method for generating, starting from a binary digital signal (X), an output signal (Y) representative of the k-th power of said binary digital signal (X), characterised by the step of:
generating at least one portion of said output signal (Y) by inserting k zeros between the adjacent bits of said binary digital signal (X).
